(19) United States
(12) Patent Application Publication
(10) Pub. No.: US 2009/0249258 A1
(43) Pub. Date: Oct. 1, 2009

(54) Simple Motion Based Input System

(76) Inventor: Thomas Zhiwei Tang, El Cerrito, CA (US)

Correspondence Address: Thomas Z. Tang, 1748 Ganges Avenue, El Cerrito, CA, 94530, US

(21) Appl. No.: 12/058,665

(22) Filed: Mar. 29, 2008

(51) Int. Cl. G06F 3/048

(52) U.S. Cl. 715/863

(57) ABSTRACT

One embodiment a programmable device embodying a program of executable instructions to perform steps including assigning multiple tasks or symbols to each of a number of motion groups; segmenting motion data from sensor(s); matching the segments to motion groups; composing and then selecting task(s) or symbol sequence(s) from the task(s) and/or symbol(s) assigned to the matched motion groups.

### CROSS-REFERENCE TO RELATED APPLICATIONS

This application claims the benefit of provisional patent application Ser. No. 60/920,525, filed 2007 Mar. 28 by the present inventor.

### FEDERALLY SPONSORED RESEARCH

Not Applicable

### SEQUENCE LISTING FOR PROGRAM

Not Applicable

### BACKGROUND

1. Field of Invention

This invention relates generally to the field of human interfaces for instruments and devices. More particularly, certain embodiments consistent with this invention relate to systems and methods for entering text, command and other messages.

2. Prior Art

A desktop computing system usually offers two basic input devices: the keyboard and the mouse. Text and command input is provided through the keyboard, while pointing (moving pointer, selecting) as well as managing UI components (resizing windows, scrolling, menu selection, etc.) are executed with the mouse. There is also some redundancy, as the keyboard can also control navigation with arrow keys and UI components with shortcut keys. However, due to space limitation and mobility requirements, the desktop input method and user experience are difficult to duplicate on off-desktop devices.

Handheld devices such as PDAs and two-way pagers primarily use on-screen “soft” keyboards, handwriting recognition, tiny physical keyboards used with the thumbs, or special gestural alphabets such as Graffiti from Palm, Inc. or Jot from Communication Intelligence Corporation (CIC). Mobile phones primarily use multiple taps on the standard 12-key number pad, possibly combined with a prediction technique such as T9. Game controllers primarily use a joystick to iterate through characters, or other methods to select letters from a keyboard displayed on the television screen.

On-screen “soft” keyboards are generally small and the keys can be difficult to hit. Even at reduced size, they consume precious screen space. Tapping on flat screen gives very little tactile feedback. Some on-screen keyboards such as Messagease and T-Cube let user use sliding motion instead of tapping for letters. Sliding motion gives an user more tactile feedback on a touch sensitive surface. However, like other on-screen keyboards, users are bound by the precise layout of on-screen keys. It requires placing finger or stylus accurately in fairly small starting cells before sliding. This type on-screen keyboards as well as the more conventional tapping only on-screen keyboards require the user to focus attention on the keyboard rather than on the output, resulting in errors and slow-downs. It is particularly problematic in ‘heads-up’ writing situations, such as when transcribing text or taking notes while visually observing events, etc. For such situations, it is important to achieve as much scale and location Independence as possible for the ease and speed of input.

Some PDA devices use alphabet character based handwriting recognition, such as Graffiti and Jot. The alphabet used can be either natural or artificially modified for reliable recognition [Goldberg, D., & Richardson, C. (1993). Touching-typing with a stylus. Proc. INTERCHI, ACM Conference on Human Factors in Computing Systems, 80-87.]. EdgeWrite defines an alphabet around the edge of a fixture to help users with motor impairment [Wobbrock, J. O., Myers, B. A., & Kembel, J. (2003). A High-Accuracy Stylus Text Entry Method. Proc. ACM Symposium on User Interface Software and Technology, UIST'03 (CHI Letters), 61-70.]. Such systems take small amount of space. The fundamental weakness of handwriting based approach, however, is the limited speed, typically estimated around 15 wpm [Card, S. K., Moran, T. P., & Newell, A. (1983). The Psychology of Human-Computer Interaction. Hillsdale, N.J.: Lawrence Erlbaum Associates Publishers.]. For Graffiti and Jot, tests has shown between 4.3-7.7 wpm performance for new users and 14-18 wpm for more advanced users [Sears, A., & Arora, R. (2002). Data entry for mobile devices: An empirical comparison of novice performance with Jot and Graffiti. Interacting with Computers, 14(5), 413-433.]. Also, these writing systems generally take a lot practice to achieve sufficient accuracy.

In contrast to Unistrokes, continuous gesture techniques do not require separation between characters, which can improve the speed of input. One example is described in U.S. Pat. No. 6,031,525, February, 2000, Perlin. An more recent development is described in U.S. Pat. No. 7,251,367 B2, July, 2007. These methods use as much screen space as on-screen keyboards and require either constant visual attention or extensive training.

### SUMMARY

In accordance with one embodiment a programmable device embodying a program of executable instructions to perform steps including assigning multiple tasks or symbols to each of a number of motion groups; segmenting motion data from sensor(s); matching the segments to motion groups; composing and selecting task(s) or symbol sequence(s) from the task(s) and/or symbol(s) assigned to the matched motion groups.

### DRAWING

### Figures

The various features of the present invention and the manner of attaining them will be described in greater detail with reference to the following description, claims, and drawings, wherein reference numerals are reused, where appropriate, to indicate a correspondence between the referenced items, and wherein

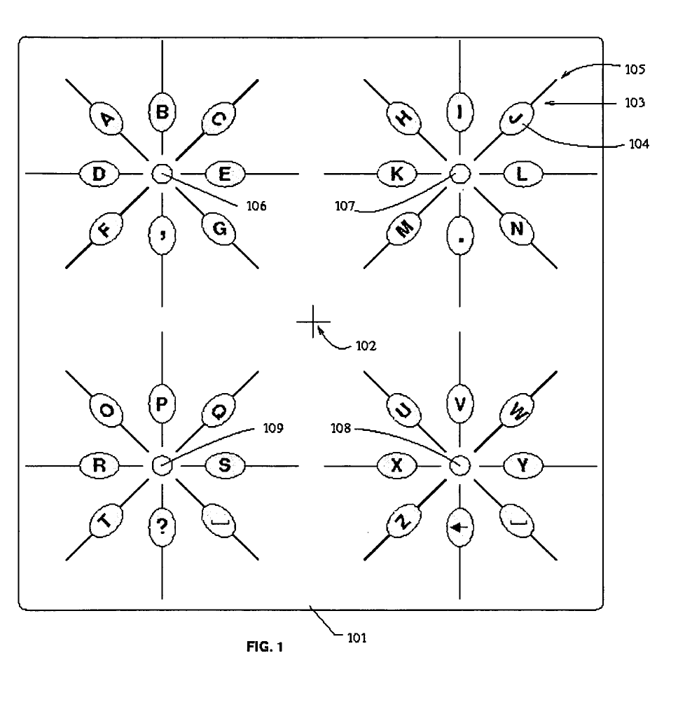

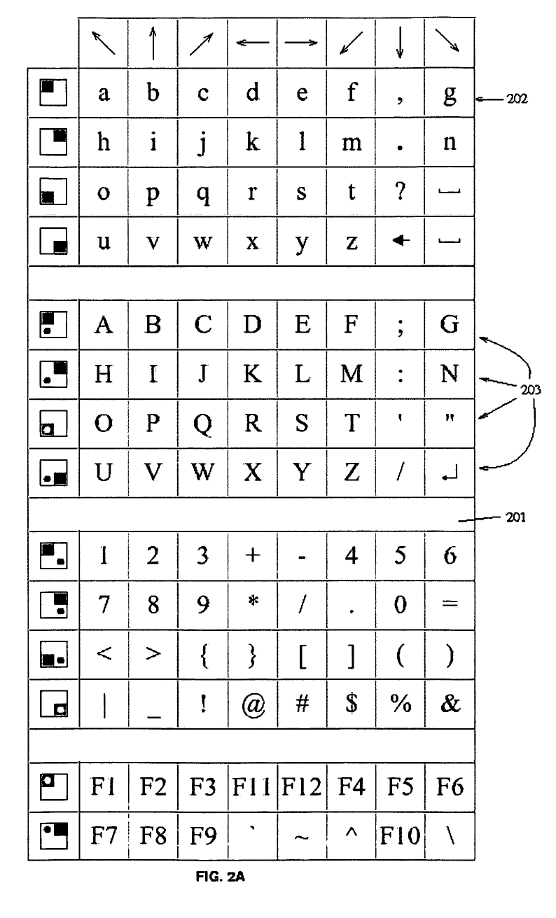

FIG. 1 is a schematic illustration of an exemplary embodiment of the present invention;

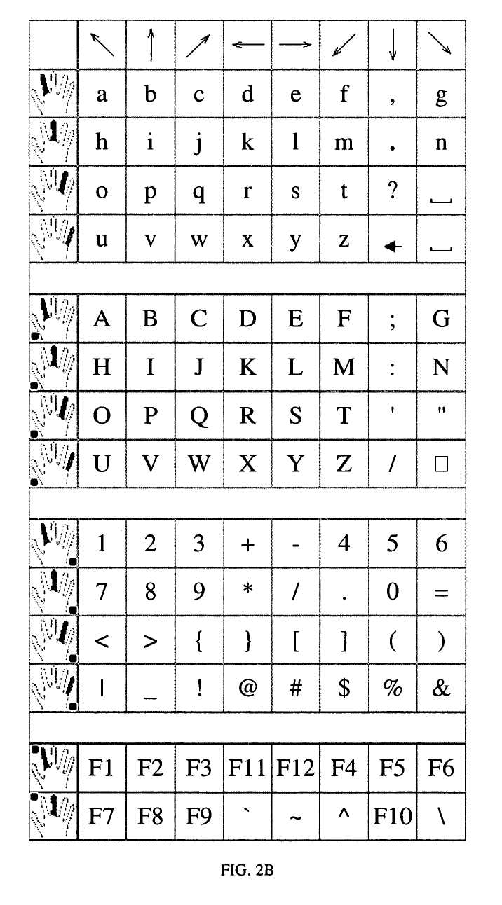

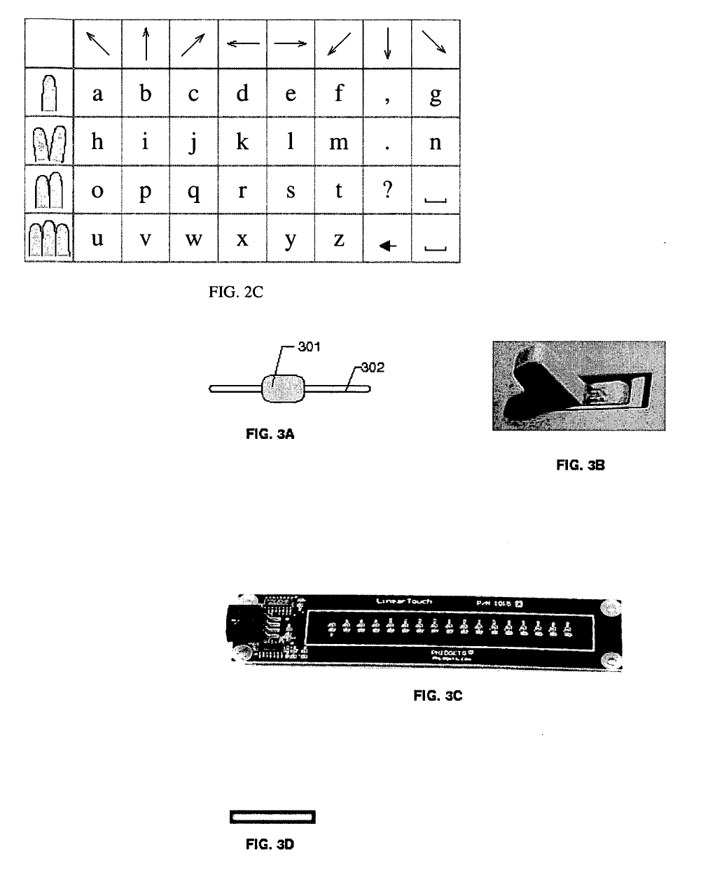

FIGS. 2A to 2C are tables illustrating the mapping between common characters/symbols and directions of movement consistent with certain embodiments of the present invention;

FIGS. 3A to 3D show some of the sensors and switches can be used to build systems consistent with certain embodiment of the present invention;

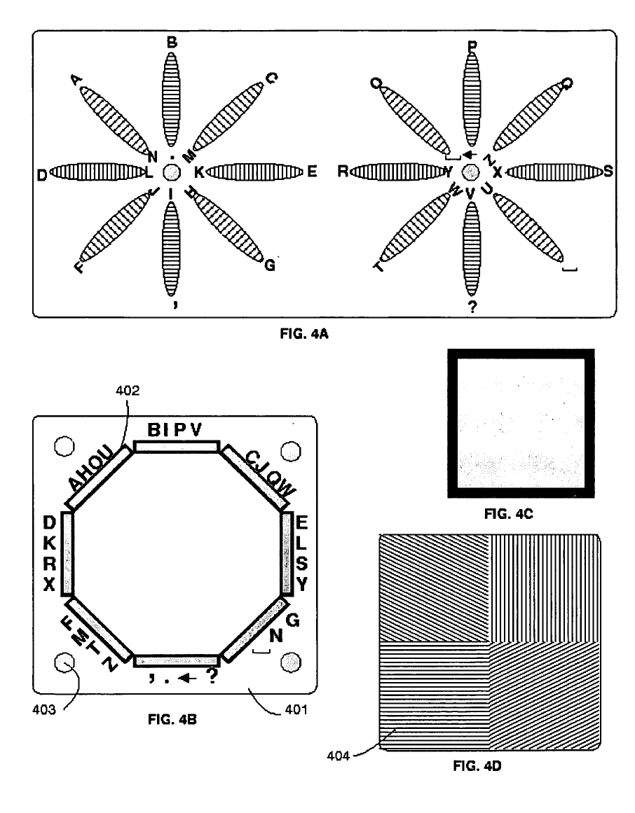

FIG. 4A is a schematic illustration of another embodiment of the invention;

FIG. 4B is a schematic illustration of another embodiment with fingerprint sensors;

FIG. 4C is a schematic illustration of another embodiment with a fingerprint sensor;

FIG. 4D is a schematic illustration of another embodiment on a touchpad;

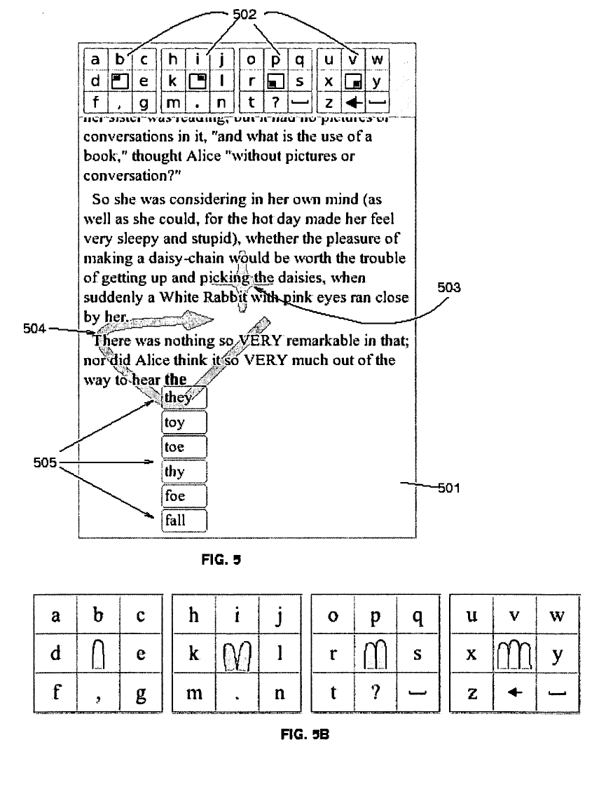

FIG. 5 is a illustration of another embodiment on a touch sensitive display;

FIG. 5B is a illustration of an alternative symbol table for multi-touch capable devices;

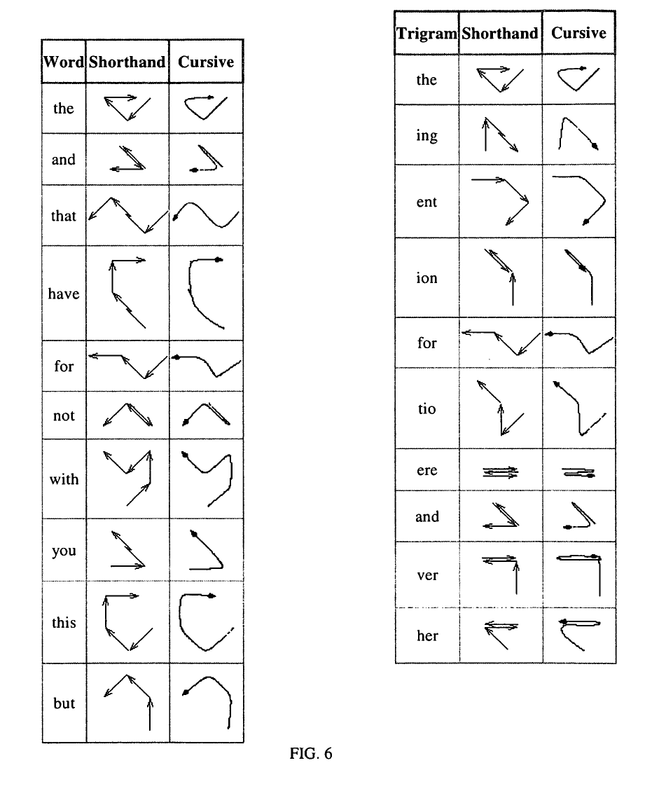

FIG. 6 illustrates common word and trigram shorthands consistent with certain embodiments of the present invention

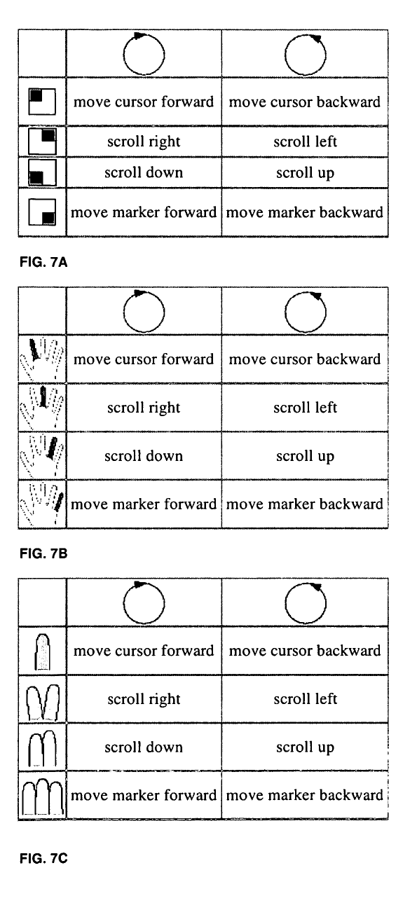

FIGS. 7A to 7C are tables illustrating the mapping between common UI tasks and circular movements consistent with certain embodiments of the present invention; and

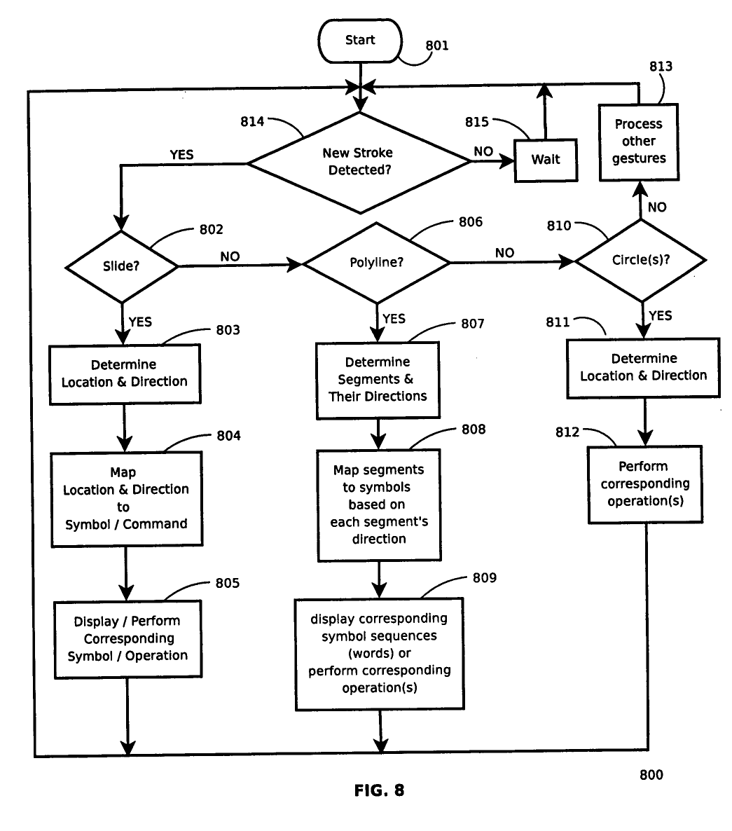

FIG. 8 is a flow chart depicting operation of a programmable device in a manner consistent with certain embodiments of the present invention.

### DETAILED DESCRIPTION

FIG. 1 illustrates an input device 101 in accordance with an embodiment of the present invention. The surface of input device 101 can be divided in 4 sections at the center 102. Each section includes a button surrounded by eight sliders 103 or slide type switches. The sliders are arranged along directions of North, Northeast, East, Southeast, South, Southwest, West, and Northwest. Each slider represent one symbol. When an user slides the knob 104 of a slider 103 toward its outer end 105, a signal for the symbol mapped to that slider will be generated. The four buttons 106-109 acts similar to an caps lock key on regular keyboard. When different buttons is pressed, sliders will be mapped to different set of symbols.

The table 201 in FIG. 2A illustrates one exemplary mapping from slide movements to symbols. The column headings on the table show the eight directions of slide movements. The row headings show the sections and mode of the buttons. The section where the slide movement been detected and the direction of the slide movement uniquely determines the symbol to input. For example, the first row 202 shows the symbols mapped to sliders in upper left section. The first four rows show symbol mapping with none of the four button pressed. The next four rows 203 show symbol mapping with lower left button 108 pressed down.

The slide movement can be detected with various types of switches and/or sensors. FIG. 3A to 3D show some examples. Slider (FIG. 3A) or similar type sensors can detect the position changes of the knob 301 along the rail 302. When an user slide the knob 301 towards one end of the slider, the position of the knob 301 can be monitored. A signal for desired symbol can be generated if the position change cross certain threshold. Since in certain embodiments such as the one shown in FIG. 1, is not necessary to detect very fine grain position change. A common light switch (FIG. 3B) or similar switches can be used in places of the sliders. Another choice is to use linear touch sensors like the one shown in FIG. 3C.

Such linear touch sensor can detect the position of contact point (by finger, stylus or other objects) on the sensor line. Such sensors are generally thin and almost flat. Also, since such sensor does not use an knob, it is no longer necessary to reset knob position. That enables such sensor to be used to produce one signal for movement towards one end and an different signal for movement towards the other end. FIG. 4A illustrates another embodiment of the present invention using linear touch sensors. It takes less space than the device in FIG. 1, since each sensor can handle two symbols in a single mode. In accordance with one embodiment, the surface of the sensors are covered with raised lines or grooves of varied length. These lines give users tactical feedback. The varied lengths of such raised lines and grooves can aid users in sensing position and direction of movement through tactical feedback.

FIG. 4B illustrates another exemplary input device accordance with an embodiment of the present invention using fingerprint sensors. Fingerprint sensor (FIG. 3D) has been used on laptop and other mobile devices for authentication purpose. Fingerprint sensor (FIG. 3D) captures fingerprint image as a finger sweeping across. The input device illustrated in FIG. 4B produce a signal whenever a finger slide across one of its sensors. Its sensors can distinguish which finger is sweeping across based on fingerprint, and use that information to generate different signals for different fingers, since each finger has distinct fingerprint. An user first register the fingerprints for his/her fingers into the device. After that the user can use different finger to produce distinct inputs. For example, sliding across sensor 402 with right index finger produces symbol ‘a’; Sliding across the same sensor with right middle finger produces symbol ‘h’. This enables the device 401 to cover the whole alphabet with eight or less sensors and less space as well. The four buttons at the corners shift the input mode in similar ways as the buttons for the device in FIG. 1. For example, when the button 403 at left bottom is pressed, the device will generate mostly upper case letters as indicated by row 5-8 in the mapping table in FIG. 2B.

Similar to device in FIG. 4A, the direction of the sweep motion can be used to discern user intent as well. FIG. 4C shows an input device in accordance with an embodiment of the present invention using a single fingerprint sensor, which has bigger surface area than the sensors used in FIG. 4B. The table in FIG. 2B shows how symbols being mapped to directions of sweeping and finger used (labeled with darker color). The table shows that four fingers are adequate for the entire English alphabet on such compact input device (FIG. 4C). The movements (sweeping or tapping) with a thumb or a finger of the other hand can be used to shift the input mode to cover upper case letters and other symbols. Each of the symbols listed in FIG. 2B is mapped to same direction of motion as in FIG. 2A. That make it ease for users to move between different type devices. Moreover, most users can choose which finger to move and which direction to move without looking at the input device. Most text input tasks becomes eye-free operation, once an user memorizes the first half of the table in FIG. 2B. That half covers the most used letters and symbols and is comparable size-wise to a multiplication table.

FIG. 4D shows an input device in accordance with another embodiment of the present invention using an touchpad 404. Touchpad has been used on most laptops as pointing device. In the device in FIG. 4D, the touch area is divided in four, an device with four separate touchpad can achieve similar results. The same symbol mapping shown in FIG. 2A can be used, with rows mapped to section of touchpad where an sliding movement (using finger, stylus or other objects) is detected. Tapping on any of the four corners of the touchpad 404 changes the input mode, accomplishes the equivalent effect as the buttons in FIG. 1. When an sliding movement cross more than one section, the section contains most of the slide or the center of the movement will be selected for symbol mapping. The other possibility is to select the section contains the starting point or the end point. The surface of each section can be covered with different texture and/or different pattern of raised lines and/or grooves. The surface features can aide users in sensing position through tactical feedback.

FIG. 5 illustrates another embodiment of the present invention on an device with touch sensitive display (or touchscreen). This device 501 share many features with the touchpad based device shown in FIG. 4D, and can be operated same way. The same symbol mapping can be used as well. Since it is integrated with display, it is more efficient in space usage. Moreover, with interactive display, it illustrates some aspects of the present invention that makes it easy to learn for novice users. The device also illustrates other aspects of the invention that enable users to be progressively more productive.

The symbol tables 502 inform user about the symbol mapping which is the same as the first four rows in FIG. 2A, but in a more compact form. Each three by three table shows symbol mapping in one section. The center cells are pictorial representation of the corresponding section. Eight cells around an center cell shows the symbols mapped to the 8 sliding directions. The relative position of a cell (versus a center cell) corresponds with the sliding direction. For example, cell ‘a’ is at upper left corner. That indicates to user a slide towards upper left direction is mapped to symbol ‘a’. With such compact layout, the symbol tables generally takes up less space than four lines of regular text. The symbol tables will update accordingly when input mode is changed. As the device in FIG. 4D, one way to change input mode for the device in FIG. 5 is to tap at one of the four corners of the touch area.

In a regular virtual keyboard, each symbol cell has to be large enough to allow a finger or stylus to tap accurately. In this device, such constraints become unnecessary, since input area is independent of the symbol tables. user can use the entire screen for slide/stroke input. Of course, for convenience, especially for novice users, the cells of the symbol tables can be made tappable the same way as regular virtual keyboard. Thus, tapping on cell ‘a’ would input letter ‘a’. Tapping on the center cell would shift the input mode. The symbol tables will in turn update accordingly.

The center mark 503, a ‘+’ shaped sign at the center of the display, is to mark the boundaries of the 4 sections. An user can use it a guide to place slides/strokes in intended sections. Both the symbol tables 502 and center mark 503 can be displayed non intrusively as semi-transparent overlay or underlay. Moreover, both can be optional. For experienced users who have memorized the symbol tables, it is no longer necessary to display the tables 502 thus free up more space for other contents. Since the tables have less cells than a multiplication table, it would be reasonable to expect sizable portion of the users can do regular text input without the symbol tables. User can also shrink or expand or minimize the symbol tables 502 by moving its borders the same way as one resizes virtual windows in graphics user interface such as Windows XP.

In the input systems presented so far, each letter is mapped to a slide movement, graphically a straight line segment. With such mapping for its letters, a word can then be mapped by an ordered list of slides or line segments. By joining the mapped line segments end to end, a word can be mapped to a polyline and then to a continuous stroke. This mapping scheme leads naturally to shorthands for words and word fragments.

Without section or other constraints, different letters can be mapped to same slide or line segment. Therefore, different words may match to same stroke. To resolve such ambiguity, the system lists matching (sometimes near matching) words, to allow user to select the intended word by tapping on it or selecting through other means. The example stroke trace 504 in FIG. 5 matches to multiple words, which are listed in tappable boxes 505 alongside the default selection, ‘the’. Each of the 3 segments in the stroke 504 can match to multiple letters. The first segment matches to f, m, t or z. The second segment matches to a, h, o, or u. The third segment matches to e, l, s, or y. Thus, the stroke 504 can be mapped to a number of words. These words can be listed according to their frequency of occurrence in general text for an user to choose. The matching word occurs most frequently in common text, in this case ‘the’, will become the default selection. The listing order can also be based on context and an user's past selections. Also, the location of first segment or the start point of an stroke can be used to resolve the ambiguity of multiple possible words. Most of the first segment of the stroke 504 falls in lower left section. In that section, the move slide movement as the first segment of the stroke 504 is mapped to ‘t’. Therefore, words starts with ‘t’ are listed first in this case. The reordering based on first segment position is optional and can be turned off by user in device configuration. When the option is turned off, the word level shorthands become completely location independent. An user can always enter single letter or symbols deterministically with simple slides (graphically a near straight lines) in corresponding sections. Because the word level shorthands share the same motions for letter level inputs, it become easier and more nature for user to learn and use the shorthands.

FIG. 6 shows tables of exemplary shorthand strokes mapped to common words and trigrams. Also shown are the cursive forms of the strokes which are easier and faster to ‘write’. For relative long words, such as ‘this’ and ‘that’, the direction requirement of the shorthand stroke can be relaxed. An user is allowed to ‘write’ the same word with an stroke in opposite direction.

On multi-touch capable touchpads and touchscreens, which is capable of tracking multiple contact points, an user can move with different number of fingers (or styli) to unambiguous select intended symbols, thus achieve location independence. An user can also differentiate the intent moving fingers (or styli) in different formation. FIG. 2C shows symbol mapping for combination of finger usage and slide position. The second row of the table shows symbol mapping for sliding with two fingers spread out. The set of multi-finger slides shown in FIG. 2C can cover the entire English alphabet. FIG. 5B shows a set of compact symbol tables can be used in place of symbol tables 502 in FIG. 5.

The device 501 illustrated in FIG. 5 can also utilize circular motions for input. The table in FIG. 7A shows how circular motions in different section can assigned to control cursor, scroll-bars, and marker, which are common in graphical user interface. Marker is used to select block of text or other on screen objects such as images. Generally, the text and/or other objects between marker and cursor are selected. The selection is empty when marker and cursor are at same position. The start point or the center of an circular motion can be used to determine the section, and in turn the corresponding row in the assignment table in FIG. 7A. For an otherwise similar device with multi-touch capable touch-screen, the same set of tasks can be assigned use the table in FIG. 7C. Using the same set of motions (clockwise and counterclock circles), an user can move the cursor with a single finger; scroll horizontally with two fingers spread out; scroll vertically with two finger close together; move the marker with three fingers. FIG. 7B shows the assignment of same set of tasks for device capable of distinguishing fingers (and/or various type of styli), such as the device illustrated in FIG. 4C. In the table, the finger to use for the corresponding tasks is indicated by darker color.

FIG. 8 depicts one simplified process 800 that the device 501 or devices with similar capacities can use to handle text entry and other tasks. The process begins at 801 after which the device check the data from its sensors for stroke signals at 814. If no stroke is detected, the process waits at 815 until a stroke is detected at 814. On a touch sensitive device such as touchpad of touch-screen, an stroke can be generated when an user touch the touch sensitive surface and then leave the surface after some movement on the surface. If the movement is too short or too slow, it would not be detected as a stroke. That can be achieved by measuring the length and duration of the movement and setting appropriate thresholds. The data for disqualified movements can be sent on to other processes for processing as those movements can be signals for button clicks, drag and drop, and so on. Once a stroke is detected, it is then classified at 802, 803 and 810.

When the points in a stroke fits a straight line statistically, the stroke would be classified as a Slide at 802. At 803, the location of the center and the direction of the slide are determined. Such properties can calculated with standard statistical method, such as linear regression. Optionally, those properties can be calculated in 802 when the data is tested for straightness. Based on the nearest cardinal or ordinal direction, the slide can then be classified into one of the eight directional groups, namely, northwest, north, northeast, west, east, southwest, south, and southeast. The input area can be divided into four sections. The slide is associated with one of the sections based on the location of its center. In 804, a letter/symbol or command/task is selected based on the classification and properties of the slide. As indicated by the columns in the table 201 in FIG. 2A, multiple symbols or tasks are assigned to each directional group. Using a look-up table in memory or other mechanism, the column wise mapping is determined by the directional group that the slide classified into. Symbols and/or tasks are assigned to each section as shown by the rows of the table 201 in FIG. 2A. The row level mapping can then be determined by the section which the slide is associated with. The symbol or task that fits both mappings is selected. Potentially, multiple symbols or tasks can be assigned to each cell. In such case, a single slide can generate signal for multiple symbols or tasks. In 805, the selected symbol or task is sent to display or execute; After that, the process goes back to 814 to check for new stroke.

For devices capable of distinguishing fingers, finger (or object) identity can be used in place of section association. In that case, the symbol(s) or task(s) can be selected using table similar to the table in FIG. 2B. Likewise, for multi-touch capable devices, the relative position of the fingers (or objects) during the movement can be used to replace section association. The selection can be made using table similar to the table in FIG. 2C. Both systems give user more location independence and potentially much better reliability in eye-free operations.

If a stroke contains direction changes with each segment fits a straight line, the stroke would be classified as a Polyline at 806. The test can be done using statistical methods such as segmented linear regression. In 807, the stroke is divided into segments. The direction of each segment can be calculated using regular statistical method such as linear regression. It is possible to perform such calculations in the test at 806. The process also check the length of each segment, and drop the segments that are too short. Each segment is then classified into one of the eight directional group based on its direction. In 808, following the column wise mapping shown by table 201 in FIG. 2A, each segment is mapped to a set of symbols (tasks) based the direction group of the segment. The sets of mapped symbols are then ordered according to the order of the segments. Words or symbol sequences are formed by taking one item of each set. For example, the stroke depicted by the trace 504 in FIG. 5 has three segments. The segments are mapped to (f, m, t, z), (a, h, o, u), and (e, l, s, y). The possible words and symbol sequences are ‘foe’, ‘fal’, ‘mal’, ‘toe’, ‘the’, etc. Based on context and frequency data, some sequences can be expanded. For example, ‘fal’, ‘mal’ and ‘the’ can be expanded to ‘fall’, ‘mall’ and ‘they’ respectively. The words and symbol sequences can then be ordered based on context and frequency of occurrence. The most frequently used word/sequence, in this case ‘the’, is assigned as default selection. The default selection as well as the list of words and sequences are then sent to display and for user to choose. The list 505 in FIG. 5 shows one common way of display such information. In some context, symbol sequences can be mapped to commands such as ‘copy’, ‘paste’, etc. Because of the underlying segment to letter mapping, it would be easier to learn and memorize than other gesture systems. Once it displays selected words or performs selected tasks, the process moves back to 814 to check for new stroke.

If a stroke is matched to a circle at 810, the process then move on to determine the center and direction (clockwise or counterclock) of the circle at 811. The circle is then associated to sections based on the location of its center. Using the table in FIG. 7A, a task can be selected based the direction and section association of the circle. After the selected task is executed at 812, the process moves back to 814 to check for new stroke.

If a stroke cannot be classified as either slide or polyline or circle, the process can try to match it against other gesture at 813 or optionally send it to other process. The process returns to check for new stroke at 814.

### CONCLUSION, RAMIFICATIONS AND SCOPE

Accordingly, the reader will see that the systems and methods described in various embodiments offers many advantages. It is easy to learn as consistent muscle movements are utilized. Users are much more likely move up from letter level input to word level shorthands. It provides smoother path for user to achieve reliable eye-free operation. Still further objects and advantages will become apparent from a consideration of the detailed description and drawings.

Although the description above contains many specificities, these should not be construed as limiting the scope of the embodiment but as merely providing illustrations of some of the presently preferred embodiments. For example, the motion or movement data can be collected with other type sensors, such as joy sticks or motion sensor attached to finger(s) or styli. Also, video camera can be employed to collect motion data. Movement can then be detected through image analysis.

I claim:

1. A method for selecting tasks or symbols, comprising:
classifying motions into groups;
assigning a plurality of tasks or symbols to each motion group;
receiving motion data from a sensor or a group of sensors;
matching the received motion data to one of the motion group;
selecting task(s) or symbol(s) from the tasks or symbols assigned to the motion group.

2. The method of claim 1, wherein the motion groups include linear motions grouped by direction, and optionally circular motions grouped by direction of rotation.

3. The method of claim 1, further comprising:
dividing the space into a plurality of sections;
assigning a plurality of tasks or symbols to each of the sections;
map the movement to one of the sections using the position of either the start point, the end point or the center of the movement;
selecting the task(s) or symbol(s) assigned to the motion group matched as well as the section mapped to the movement.

4. The method of claim 2, further comprising:
dividing the space into a plurality of sections;
assigning a plurality of tasks or symbols to each of the sections;
map the movement to one of the sections using the position of either the start point, the end point or the center of the movement;
selecting the task(s) or symbol(s) assigned to the motion group matched as well as the section mapped to the movement.

5. The method of claim 1, further comprising:
assigning a plurality of tasks to each of a plurality of movable objects;
receiving physical feature(s) for the object in motion from a sensor or a group of sensors;
identifying the object involved in motion based on the received feature(s);
selecting the tasks assigned to the motion group matched as well as the object identified.

6. The method of claim 5, wherein the movable objects are identified by fingerprints and/or surface features.

7. The method of claim 2, further comprising:
assigning a plurality of tasks or symbol(s) to each of a plurality of movable objects;
receiving physical feature(s) for the object in motion from a sensor or a group of sensors;
identifying the object involved in motion based on the received feature(s);
selecting the tasks assigned to the motion group matched as well as the object identified.

8. The method of claim 7, wherein the movable objects are identified by fingerprints and/or surface features.

9. The method of claim 1, further comprising:
tracking the motion data of a plurality of objects;
further selecting the task(s) or symbol(s) according to the relative positions of the objects during the movement.

10. The method of claim 2, further comprising:
tracking the motion data of a plurality of objects;
further selecting the task(s) or symbol(s) according to the relative positions of the objects during the movement.

11. A programmable device tangibly embodying a program of executable instructions to perform method steps for selecting tasks or symbols, comprising:
classifying motions into groups;
assigning a plurality of tasks or symbols to each motion group;
receiving motion data from a sensor or a group of sensors;
matching the received motion data to one of the motion groups;
selecting task(s) or symbol(s) from the tasks or symbols assigned to the motion group.

12. The device of claim 11, wherein the motion groups include linear motions grouped by direction, and optionally circular motions grouped by direction of rotation.

13. The device of claim 12, wherein the program embodied further comprising executable instructions to perform method steps comprising:
dividing the space into a plurality of sections;
assigning a plurality of tasks or symbols to each of the sections;
map the movement to one of the sections using the position of either the start point, the end point or the center of the movement;
selecting the task(s) or symbol(s) assigned to the motion group matched as well as the section mapped to the movement.

14. The device of claim 12, wherein the program embodied further comprising executable instructions to perform method steps comprising:
assigning a plurality of tasks or symbols to each of a plurality of movable objects;
receiving physical feature(s) for the object in motion from a sensor or a group of sensors;
identifying the object involved in motion based on the received feature(s);
selecting the task(s) or symbol(s) assigned to the motion group matched as well as the object identified.

15. The device of claim 14, wherein the movable objects are identified by fingerprints and/or surface features.

16. The device of claim 12, wherein the program embodied further comprising executable instructions to perform method steps comprising:
tracking the motion data of a plurality of objects;
further selecting the task(s) or symbol(s) according to the relative positions of the objects during the movement.

17. A method for selecting words or symbol sequences, comprising:
classifying motions into groups by direction;
assigning a plurality of symbols to each motion group;
receiving motion data from a sensor or a group of sensors;
dividing the motion data into segments at the points of direction changes;
matching each segment to one of the motion group;
composing symbol sequences using the symbols assigned to the matched motion groups and the order of the segments;
selecting words or symbol sequences from the composed symbol sequences.

18. The method of claim 17, wherein the composed symbol sequences are ordered by frequency of occurrence.

19. A programmable device tangibly embodying a program of executable instructions to perform method steps for selecting words or symbol sequences, comprising:
classifying motions into groups by direction;
assigning a plurality of symbols to each motion group;
receiving motion data from a sensor or a group of sensors;
dividing the motion data into segments at the points of direction changes;
matching each segment to one of the motion group;
composing symbol sequences using the symbols assigned to the matched motion groups and the order of the segments;
selecting words or sequences from the composed symbol sequences.

20. The device of claim 19, wherein the program embodied further comprising executable instructions to order the composed symbol sequences according to frequency of occurrence.
